(19) United States
(12) Patent Application Publication
(10) Pub. No.: US 2012/0173308 A1
(43) Pub. Date: Jul. 5, 2012

(54) OPTIMIZING PACKAGE DELIVERY USING SOCIAL NETWORKS

(75) Inventors: Kevin C. Brown, Eastleigh (GB); James Billingham, Eastleigh (GB); David C. Conway-Jones, Winchester (GB); Robert S. Smart, Southampton (GB); Graham White, Alton (GB)

(73) Assignee: International Business Machines Corporation, Armonk, NY (US)

(21) Appl. No.: 12/982,776

(22) Filed: Dec. 30, 2010

(51) Int. Cl. G06Q 30/00; G06Q 99/00

(52) U.S. Cl. 705/14.1; 705/26.81; 705/319

(57) ABSTRACT

In an embodiment of the invention, a method for optimizing package delivery using social networks is provided. The method includes receiving an order to purchase a product by a purchaser in an e-commerce computing application executing in memory of a host server from over a computer communications network, retrieving a list of social networking contacts for the purchaser, determining whether or not a contact amongst the social networking contacts has ordered a product from the e-commerce computing application, and rendering a prompt in the e-commerce computing application to the purchaser to consolidate shipment of the product ordered by the purchaser with a product ordered by the contact in response to determining that the contact has also ordered a product from the e-commerce computing application not yet shipped to the contact.

### BACKGROUND OF THE INVENTION

1. Field of the Invention

The present invention relates to the field of e-commerce computing and more particularly to shipping and delivery management in an e-commerce computing system.

2. Description of the Related Art

E-commerce systems have evolved to provide virtual storefronts whose operational capabilities far exceed those of the traditional, brick and mortar store. In the brick and mortar store, each of the sales, marketing, order fulfillment, inventory, and customer service functions remain the separate responsibilities of corresponding business roles, whereas in a well-defined e-commerce system, each of the sales, marketing, order fulfillment, inventory, and customer service can be integrated in a single computing system in a highly automated fashion. Consequently, a more optimal business operation can result in which data flows between different functional subsystems seamlessly to facilitate the daily conduct of business managed by the e-commerce system.

In the prototypical e-commerce system, an on-line catalog of available goods and/or services for sale can be established along with associated pricing. Customers can be provided with a store front user interface through which customers can browse the on-line catalog. When a customer desires to purchase a product or service, the customer can indicate so, causing the addition of the selected product or service to an on-line shopping cart, though it is also known to bypass the shopping cart model in favor of direct purchase model.

Once a product has been purchased in an e-commerce system, shipment and delivery of the purchased product must be coordinated through the e-commerce system. Typically, the purchaser selects a mode of shipment ranging from in-store pickup to overnight delivery to ground transport. Of course, in many cases the purchaser will be responsible for paying any shipping costs, which are usually substantial. In fact, for many products, the cost of shipment can form a substantial component of the purchase transaction. The determination of the cost and mode of shipping, however, is usually done on a purchaser-by-purchaser basis. Having recognized the high cost of shipping purchased products, some retailers deployed into the e-commerce system logic for aggregating different orders for the same purchaser into a single shipment in an attempt to reduce the cost of shipping.

### BRIEF SUMMARY OF THE INVENTION

Embodiments of the invention address deficiencies in the field of shipment and delivery processing for e-commerce transactions and provide for a novel and non-obvious method, data processing system, and computer program product for package delivery optimization. In an embodiment of the invention, a method for package delivery optimization is provided and includes receiving an order to purchase a product by a purchaser, retrieving a list of social network contacts for the purchaser, determining whether or not a contact among the purchaser's social networking contacts also ordered a product, and prompting the purchaser to consolidate shipment of the product ordered by the purchaser with the product ordered by the contact among the purchaser's social networking contacts.

Another embodiment of the invention provides a package delivery system for optimizing package delivery using social networks. The system can include a host server configured to support an e-commerce computing application and a package delivery optimization module. The package delivery optimization module can include program code for retrieving the purchaser's social network contact list, determining if there is a match between the purchaser's social network contact list and the e-commerce computing application's order list, and prompting the purchaser with a delivery consolidation option.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for package delivery optimization;

FIG. 2 is a schematic illustration of an e-commerce data processing system configured for optimizing package delivery using social networks; and,

FIG. 3 is a flow chart illustrating a process for optimizing package delivery using social networks.

### DETAILED DESCRIPTION OF THE INVENTION

In accordance with an embodiment of the invention, an order can be received for a product in an e-commerce data processing system. In the course of processing the order in the e-commerce data processing system, shipment instructions can be received from the purchaser of the product, including for example, a preferred mode of shipment and an address to which the product once packaged is to be delivered. Of note, a social networking contact list can be retrieved for the purchaser and the contacts on the list can be compared to a list of other purchasers purchasing products not yet shipped from the e-commerce data processing system. Thereafter, the purchaser can select a particular contact in the social networking list also appearing in the list of other purchasers for which the purchased products of the selected particular contact can be aggregated with the product selected for purchase by the purchaser in a single shipment. In this way, the consolidation of shipment of the ordered products of the purchaser and the selected particular contact may save on shipping costs.

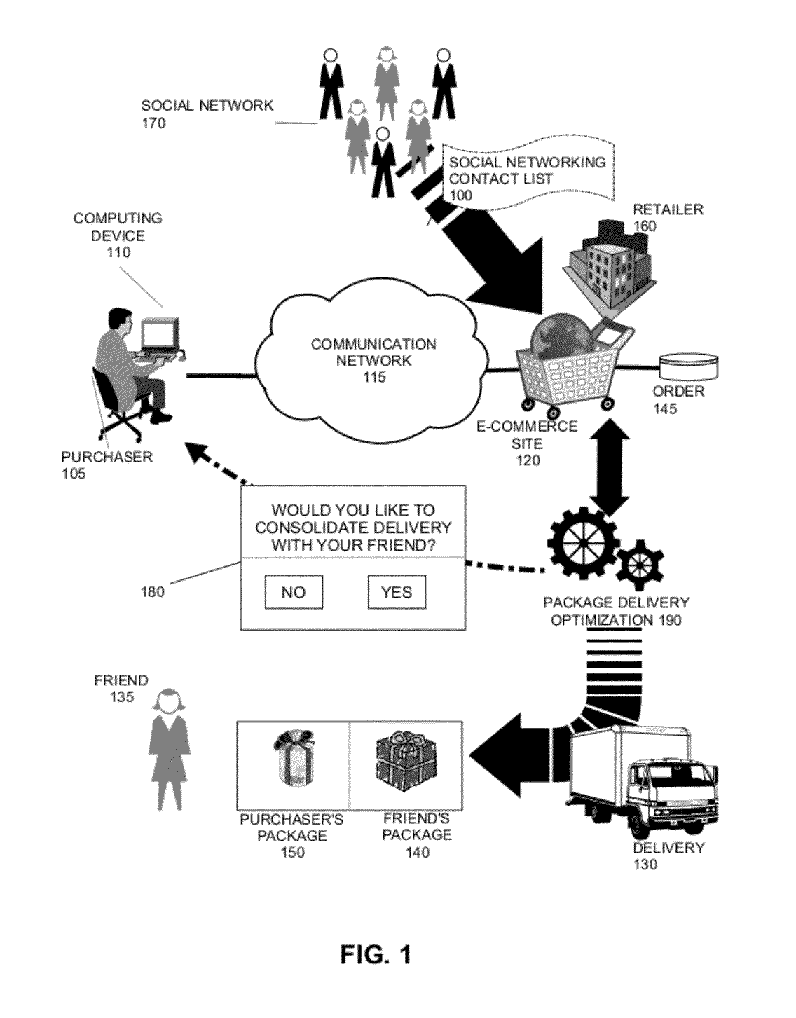

In further illustration, FIG. 1 pictorially shows a process for package delivery optimization. As shown in FIG. 1, a purchaser 105 by way of a computing device 110 accesses via a computer communication network 115 an e-commerce site 120 executing in memory of a host server of a retailer 160. The purchaser 105 subsequently submits an order 145 to purchase a product from the retailer 160 at the e-commerce site 120. Upon receiving the order 145 to purchase the product, package delivery optimization logic 190 operating in concert with the e-commerce site 120, retrieves a social networking contact list 100 of the purchaser 105 from a social networking site 170. Upon accessing the social networking contacts list 100 of the purchaser 105, the package delivery optimization logic 190 determines whether or not a friend 135 of the purchaser 105 listed within the social networking contacts list 100 also has ordered a product from the retailer 160 that has yet to ship to the friend 135.

If so, the package delivery optimization logic 190 directs the e-commerce site 120 to render a prompt 180 to the computing device 110 inquiring whether or not the purchaser 105 would agree to consolidate shipment of the ordered product of the purchaser 105 with that of the friend 135. Optionally, the package delivery optimization logic 190 can calculate and then direct display of a prospective reduction of cost to the purchaser 105 for consolidating shipment of a package 150 containing the product ordered by the purchaser 105 with shipment of a package 140 containing the product ordered by the friend 135.

In response to the purchaser 105 affirmatively selecting to consolidate shipment of the purchaser's package 150 with the friend's package 140, the package delivery optimization logic 190 may provide a discount or rebate on shipment costs to the purchaser 105. The package delivery optimization logic 190 is not limited to only offering a discount or rebate on shipment costs to the purchaser 105, but can include any incentive to encourage the purchaser 105 to consolidate shipment of the ordered product with that of the product ordered by the friend 135. The package delivery optimization logic 190 may also allow the purchaser 105 to set a delivery date for some time in the future to increase the possibility that a friend from the social networking contacts list 10 has ordered a product from the e-commerce site 120. As yet a further option, the purchaser 105 may set a total price threshold, so that the ordered products of the purchaser will be consolidated for shipment only when enough additional products have been purchased from the e-commerce site 120 to meet a total price threshold. In any case, once consolidation of shipment has been selected by the purchaser 105, both the purchaser's package 150 and the contact's package 140 can be shipped in a consolidated shipment by delivery service 130 to the friend 135.

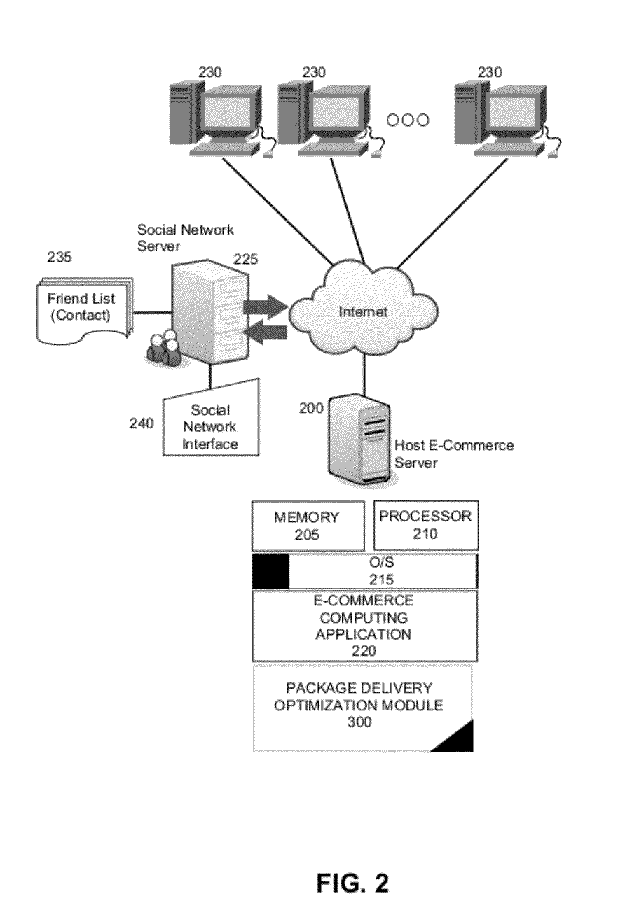

The process described in connection with FIG. 1 can be implemented in an e-commerce data processing system. In further illustration, FIG. 2 schematically shows an e-commerce data processing system configured for optimizing package delivery using social networks. The system can include a host server 200. The host server 200 can include at least one processor 210 and memory 205 supporting the execution of n operating system (O/S) 215. The O/S 215 in turn can host the operation of an e-commerce computing application 220 publishing an e-commerce site over a global computer communications network such as the Internet, and managing access thereto by different computing devices 230 through respective content browsers (not shown).

A package delivery optimization module 300 can execute in the memory 205 of the host server 200 and can be coupled to the e-commerce computing application 220. The package delivery optimization module 300 can include program code, which when executed by at least one processor 210 of the host server 200, responds to a request by a purchaser to purchase and ship a product or products in the e-commerce computing application 220 by retrieving over the Internet from a social networking server 225 by way of a social network interface 240 a list of social networking contacts 235 for purchaser in a social network provided by the social networking server 225. In this regard, the social network interface 240 can be a Web page providing access to the list of social networking contacts 235 or an application programming interface (API) to the social networking server 225 that permits programmatic access to the list of social networking contacts 235, or a query interface to a data store in which the list of social networking contacts 235 is stored.

Once the list of social networking contacts 235 has been retrieved for the purchaser, the program code can be further enabled to determine whether or not there exists in the list of social networking contacts 235 for the purchaser at least one friend who also has ordered a product or products through the e-commerce computing application 220, but the product or products have not yet shipped to the friend. Finally, in response to identifying a friend who also has ordered a product or products through the e-commerce computing application 220, but those product or products have not yet shipped, the program code even yet further can prompt the purchaser over the Internet to consolidate shipment of the product or products of the purchaser with the product or products of the friend.

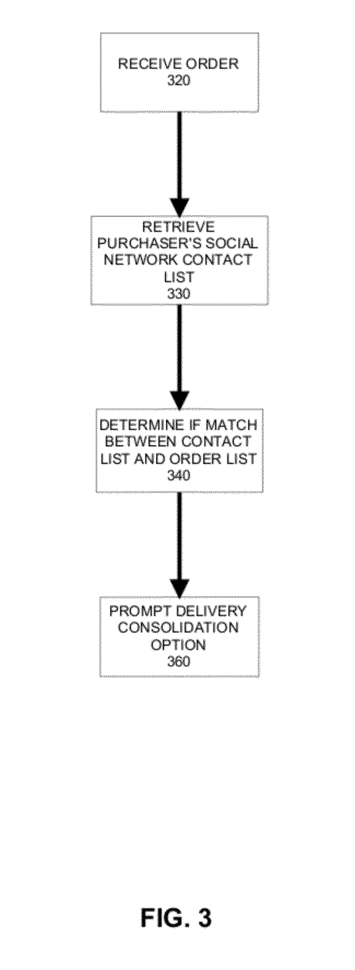

In even yet further illustration of the operation of the program code of the package delivery optimization module 300, FIG. 3 is a flow chart illustrating a process for optimizing package delivery using social networks. Beginning in block 320, an order can be received from a purchaser to purchase a product through an e-commerce site. In block 330, a social network can be contacted over the Internet and a request can be issued to return to the e-commerce site a list of friends in the social network for the purchaser. In block 340, it can be determined whether or not a friend of the purchaser in the list of friends has also purchased a product from the e-commerce site that has not yet shipped to the friend. If so, in block 360 a prompt can be generated through the e-commerce site for the purchaser to consolidate delivery of the product purchased by the purchaser with the product purchased by the friend. Optionally, a prospective cost savings for having consolidating the shipment can be displayed to the purchaser along with the prompt.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s).

It should be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Also note that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process, such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A package delivery optimization method comprising:
receiving an order to purchase a product by a purchaser in an e-commerce computing application executing in memory of a host server from over a computer communications network;
retrieving a list of social networking contacts for the purchaser;
determining whether or not a contact amongst the social networking contacts also has ordered a product from the e-commerce computing application; and,
rendering a prompt in the e-commerce computing application to the purchaser to consolidate shipment of the product ordered by the purchaser with a product ordered by the contact in response to determining that the contact also has ordered a product from the e-commerce computing application not yet shipped to the contact.

2. The method of claim 1, further comprising:
providing a discount on shipment costs to the purchaser for consolidating shipment of the product ordered by the purchaser with the product ordered by the contact.

3. The method of claim 1, further comprising:
providing a rebate to the purchaser for consolidating shipment of the product ordered by the purchaser with the product ordered by the contact.

4. The method of claim 1, further comprising:
calculating a prospective reduction of cost to the purchaser for consolidating shipment of the product ordered by the purchaser with the product ordered by the contact; and,
displaying the prospective reduction of cost to the purchaser in the prompt.

5. The method of claim 1, wherein retrieving a list of social networking contacts for the purchaser, comprises:
retrieving a user identification and password for the purchaser for a social network; and,
accessing the social network from within the e-commerce computing application using the user identification and password to direct the social network to provide the list of social networking contacts for the purchaser.

6. A computer program product for package delivery optimization the computer program product comprising:
a computer readable storage medium having computer readable program code embodied therewith, the computer readable program code comprising:
computer readable program code for receiving an order to purchase a product by a purchaser in an e-commerce computing application;
computer readable program code for retrieving a list of social networking contacts for the purchaser;
computer readable program code for determining whether or not a contact amongst the social networking contacts also has ordered a product from the e-commerce computing application; and,
computer readable program code for rendering a prompt in the e-commerce computing application to the purchaser to consolidate shipment of the product ordered by the purchaser with a product ordered by the contact in response to determining that the contact also has ordered a product from the e-commerce computing application not yet shipped to the contact.

7. The computer program product of claim 6, further comprising:
computer readable program code for providing a discount on shipment costs to the purchaser for consolidating shipment of the product ordered by the purchaser with the product ordered by the contact.

8. The computer program product of claim 6, further comprising:
computer readable program code for providing a rebate to the purchaser for consolidating shipment of the product ordered by the purchaser with the product ordered by the contact.

9. The computer program product of claim 6, further comprising:
computer readable program code for calculating a prospective reduction of cost to the purchaser for consolidating shipment of the product ordered by the purchaser with the product ordered by the contact; and,
computer readable program code for displaying the prospective reduction of cost to the purchaser in the prompt.

10. The computer program product of claim 6, wherein the computer readable program code for wherein retrieving a list of social networking contacts for the purchaser, comprises:
computer readable program code for retrieving a user identification and password for the purchaser for a social network; and,
computer readable program code for accessing the social network from within the e-commerce computing application using the user identification and password to direct the social network to provide the list of social networking contacts for the purchaser.

11. An e-commerce data processing system configured for optimizing package delivery using social networks comprising:
a host server with at least one processor and memory;
an e-commerce computing application executing on the host server;
a package delivery optimization module coupled to the e-commerce computing application, the module comprising program code enable to receive an order to purchase a product by a purchaser, to retrieve a list of social networking contacts for the purchaser, to determine whether or not a contact amongst the social networking contacts has also ordered a product from the e-commerce computing application, and to prompt the purchaser to consolidate shipment of the product ordered by the purchaser with a product ordered by the contact.

12. The system of claim 11, wherein the program code of the package delivery module is further enabled to provide a discount on shipment costs to the purchaser for consolidating shipment of the product ordered by the purchaser with the product ordered by the contact.

13. The system of claim 11, wherein the program code of the package delivery module is further enabled to provide a rebate to the purchaser for consolidating shipment of the product ordered by the purchaser with the product ordered by the contact.

14. The system of claim 11, wherein the program code of the package delivery module is further enabled to calculate a prospective reduction of cost to the purchaser for consolidating shipment of the product ordered by the purchaser with the product ordered by the contact and to display the prospective reduction of cost to the purchaser in the prompt.

15. The system of claim 11, wherein the program code to retrieve a list of social networking contacts for the purchaser, comprises:
retrieving a user identification and password for the purchaser for a social network; and,
accessing the social network from within the e-commerce computing application using the user identification and password to direct the social network to provide the list of social networking contacts for the purchaser.
